(19) United States
(12) Patent Application Publication
(10) Pub. No.: US 2007/0201914 A1
(43) Pub. Date: Aug. 30, 2007

(54) Fixing device and image forming apparatus

(75) Inventors: Kikunosuke Tsuji, Osaka-shi (JP); Syoukou Gon, Osaka-shi (JP); Hiroshi Kusumoto, Osaka-shi (JP); Yuzuru Nanjo, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/711,335

(22) Filed: Feb. 27, 2007

(30) Foreign Application Priority Data
Feb. 27, 2006 (JP) 2006-050181

(51) Int. Cl. G03G 15/20

(52) U.S. Cl. 399/328; 399/330; 399/329

(57) ABSTRACT

A fixing device includes a heated body of a hollow cylindrical shape that is made of a conductive material and driven to rotate about an axis center, and a coil that heats the heated body by means of induction heating. The coil is formed of plural coil elements divided in an axial direction of the coil parallel to a rotational axis direction of the heated body, and the coil elements are aligned in such a manner that directions of magnetic fields of adjacent coil elements are opposite to each other. The heated body is set stationary in the rotational axis direction and the coil is reciprocally driven in the axial direction.

### BACKGROUND OF THE INVENTION

1. Field of the Invention

The present invention relates to a fixing device having a heated body heated by the induction heating method, and an image forming apparatus equipped with the fixing device.

2. Description of the Related Art

A fixing device incorporated into an image forming apparatus, such as a copying machine, a facsimile machine, and a laser printer, generally includes a heat roller (fixing roller) and a pressure roller that is pressed against the heat roller. A recording medium bearing a pre-fixed toner image is nipped and carried by a nip portion defined between the heat roller and the pressure roller for the pre-fixed toner image on the recording medium to be fused thereon. Conventionally, a halogen heater is used often as the heat source of the heat roller. However, to meet an increasing need for a shorter warm-up time and energy saving, it has been proposed to adopt a heat source of the induction heating (IH) method.

In a heat roller of the induction heating method, a coil, around which is helically wound a copper wire with turns proceeding in the rotational axis direction, is disposed inside a roller main body (a cylindrical body, a heated body) made of a conductive material. A high-frequency current is flown to the coil and an induction eddy current is generated in the roller main body by the resulting high-frequency magnetic field, which gives rise to Joule heating owing to the surface resistance of the roller main body.

Incidentally, in a case where one coil is disposed inside the roller main body and heated in the heat roller of the induction heating method as described above, magnetic fluxes are dense in the roller main body at a portion opposing the center portion of the coil, whereas magnetic fluxes are rough in the roller main body at portions opposing the both ends of the coil. Hence, the temperature of the roller main body is high at the center portion and low at the both ends. In other words, a temperature irregularity occurs in the roller main body in the rotational axis direction, which poses a problem that desired distribution and orientation of temperature cannot be achieved.

In order to solve this problem, JP-A-2001-242727 discloses a technique of making a temperature distribution uniform by dividing the coil into plural parts to smoothen the magnetic field entirely in the rotational axis direction of the roller main body. More specifically, the coil is divided into plural coil elements in the rotational axis direction of the roller main body, and a high-frequency current is flown to the coil elements aligned in such a manner that the directions of the magnetic fields of adjacent coil elements are opposite to each other. Accordingly, because the polarities repel each other in an opposing portion (joint portion) of the adjacent coil elements, it is possible to make magnetic fluxes going into the heat roller uniform, which can in turn lessen a temperature irregularity of the heat roller in the rotational axis direction.

According to the technique described above, a temperature irregularity of the heat roller in the rotational axis direction can be lessened as a whole; however, the magnetic field fails to reach the roller main body in the opposing portion of the adjacent coil elements, which gives rise to a local temperature drop in this joint portion. In short, a temperature irregularity occurs in part, and the problem that desired distribution and orientation of temperature cannot be achieved remains unsolved.

### SUMMARY OF THE INVENTION

An advantage of the invention is to provide a fixing device using a coil divided into plural coil elements, which is a fixing device of the induction heating method capable of achieving desired distribution and orientation of temperature by suppressing local temperature drops in the opposing portions of adjacent coil elements, and an image forming apparatus equipped with such a fixing device.

A fixing device according to one aspect of the invention that achieves the advantage includes a heated body of a hollow cylindrical shape that is made of a conductive material and driven to rotate about an axis center, and a coil that heats the heated body by means of induction heating, wherein the coil is formed of plural coil elements divided in an axial direction of the coil parallel to a rotational axis direction of the heated body and the coil elements are aligned in such a manner that directions of magnetic fields of adjacent coil elements are opposite to each other, and the heated body is set stationary in the rotational axis direction and the coil is reciprocally driven in the axial direction.

An image forming apparatus according to another aspect of the invention includes: an image forming portion configured to apply transfer processing of a toner image to a recording sheet; a fixing portion configured to apply fixing processing to the recording sheet onto which the toner image has been transferred; and an apparatus main body that accommodates the image forming portion and the fixing portion, wherein the fixing portion includes the configuration described as above.

### BRIEF DESCRIPTION OF THE DRAWINGS

FIG. 1 is an explanatory view when viewed in a cross-sectional transverse plane to schematically describe the internal structure of an image forming apparatus (printer) to which a fixing device of the invention is applied.

FIGS. 2A and 2B are views showing the configuration of a fixing device according to a first embodiment of the invention, FIG. 2A being a schematic perspective view and FIG. 2B being a cross section taken on line IIB-IIB of FIG. 2A.

FIG. 3 is a sectional explanatory view showing a major configuration of a reciprocal driving mechanism in the fixing device of the first embodiment.

FIGS. 4A and 4B are explanatory views showing a temperature distribution in a heated body of the fixing device, FIG. 4A showing a temperature distribution of a fixing device in the related art and FIG. 4B showing a temperature distribution of the fixing device according to the first embodiment of the invention.

FIG. 5 is a sectional explanatory view showing a major configuration of a reciprocal driving mechanism in a fixing device according to a second embodiment of the invention.

FIG. 6 is a cross section showing the configuration of a fixing device according to a third embodiment of the invention.

FIG. 7 is a cross section showing the configuration of a fixing device according to a fourth embodiment of the invention.

### DETAILED DESCRIPTION OF THE PREFERRED EMBODIMENTS

Hereinafter, the best mode of a fixing device of the invention and an image forming apparatus equipped with this fixing device will be described in detail with reference to the drawings.

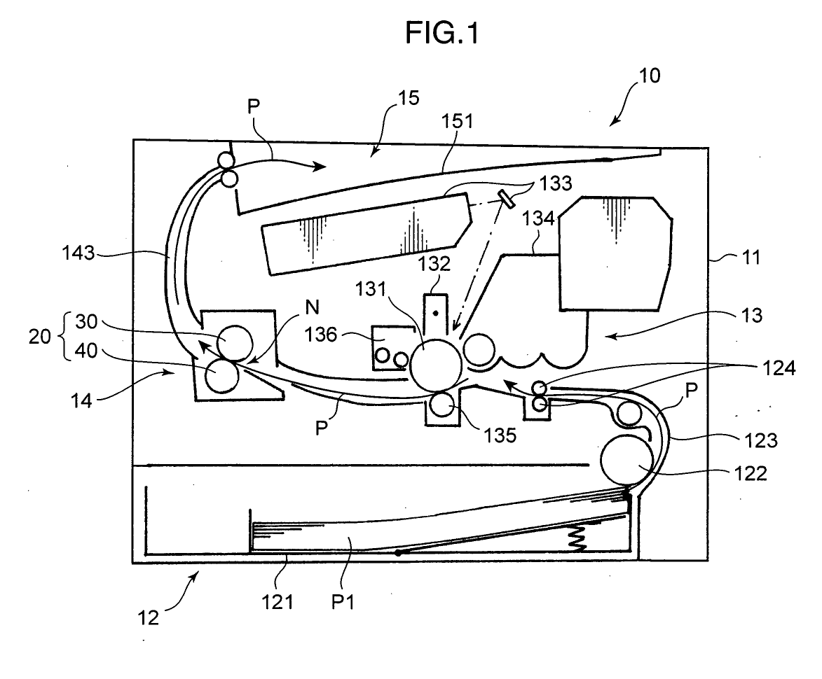

Firstly, a printer (image forming apparatus) 10 as one example of an image forming apparatus to which a fixing device 20 according to a first embodiment of the invention is applied will be described with reference to FIG. 1. FIG. 1 is an explanatory view when viewed in a cross-sectional transverse plane used to schematically describe the internal structure of the printer equipped with the fixing device of this embodiment. As is shown in the drawing, the printer 10 is formed by housing, in an apparatus main body 11, a paper storing portion 12 that stores sheets of paper P used for print processing, an image forming portion 13 that applies image transfer processing to sheets of paper P one by one that are extracted from a pile of sheets of paper, P1, stored in the paper storing portion 12, and a fixing portion 14 that applies fixing processing to a recording sheet P done with the transfer processing in the image forming portion 13, and by providing a paper discharge portion 15 on top of the apparatus main body 11 for a recording sheet P done with the fixing processing in the fixing portion 14 to be discharged thereon.

The paper storing portion 12 is provided with one or a specific number of paper cassettes 121 (one in the first embodiment) attached to the apparatus main body 11 in a re-attachable manner. A pick-up roller 122 that extracts sheets of paper P one by one from the pile of sheets of paper, P1, is provided at the downstream end (the right side in FIG. 1) of the paper cassette 121. A recording sheet P extracted from the paper cassette 121 by the driving of the pick-up roller 122 is fed to the image forming portion 13 via a paper carrying path 123 and a pair of register rollers 124 provided at the downstream end of the paper carrying path 123.

The image forming portion 13 applies transfer processing to a recording sheet P according to image information sent from a computer or the like by means of electric transmission. The image forming portion 13 includes a photoconductive drum 131 provided in a rotatable manner about the rotation axis thereof extending in the front-back direction (a direction perpendicular to the sheet surface of FIG. 1), and a charger 132, an exposing device 133, a developing device 134, a transfer roller 135, and a cleaning device 136 that are provided sequentially in a clockwise direction from the position directly above the photoconductive drum 131 to go along the peripheral surface thereof.

The photoconductive drum 131 is to form an electrostatic latent image and a toner image corresponding to this electrostatic latent image on the peripheral surface thereof. An amorphous silicon layer suitable to form an electrostatic latent image and a toner image is layered on the peripheral surface of the photoconductive drum 131.

The charger 132 is to form charges uniformly on the peripheral surface of the photoconductive drum 131 that is rotating about the rotation axis thereof in the clockwise direction. The example shown in FIG. 1 adopts a method for conferring charges to the peripheral surface of the photoconductive drum 131 by means of corona discharge. A charging roller may be adopted instead of the charger 132 as a member to confer charges to the peripheral surface of the photoconductive drum 131. The charging roller confers charges to the peripheral surface of the photoconductive drum 131 by abutting thereon while being driven rotated.

The exposing device 133 irradiates a laser beam having differences in intensity according to the image data sent from an outside device, such as a computer, by means of electric transmission to the peripheral surface of the photoconductive drum 131 that is rotating. Charges are erased from the peripheral surface of the photoconductive drum 131 in a portion where a laser beam was irradiated, and an electrostatic latent image is consequently formed on the peripheral surface of the photoconductive drum 131.

The developing device 134 forms a toner image on the peripheral surface of the photoconductive drum 131 by supplying the peripheral surface of the photoconductive drum 131 with toner particles which is in turn attracted onto the peripheral surface in a portion where the electrostatic latent image is formed.

The transfer roller 135 transfers the toner image charged positively and formed on the peripheral surface of the photoconductive drum 131 onto a recording sheet P fed to a position beneath the photoconductive drum 131. The transfer roller 135 therefore confers negative charges, which are charged to the opposite polarity to that of charges conferred to the toner image, to the recording sheet P.

The toner image is transferred onto the recording sheet P that has reached the position beneath the photoconductive drum 131. The transfer processing to the recording sheet P is performed by stripping the positively charged toner image on the peripheral surface of the photoconductive drum 131 toward the surface of the negatively charged recording sheet P while the recording sheet P is pressed and nipped by the transfer roller 135 and the photoconductive drum 131.

The cleaning device 136 is to clean the photoconductive drum 131 by removing toner remaining on the peripheral surface thereof after the transfer processing. The peripheral surface of the photoconductive drum 131 cleaned by the cleaning device 136 heads for the charger 132 again for the following image forming processing.

The fixing portion 14 is to apply fixing processing by heating to the toner image on a recording sheet P done with the transfer processing in the image forming portion 13. The fixing portion 14 includes a fixing device 20 having a heat roller (fixing roller) 30 that applies heat to the recording sheet P and a pressure roller 40 disposed oppositely below the heat roller 30. The recording sheet P done with the transfer processing is sent to a nip portion N defined between the heat roller 30 and the pressure roller 40, and undergoes the fixing processing with heat received from the heat roller 30 as it passes by the nip portion N. The recording sheet P after the fixing processing is discharged onto the paper discharge portion 15 by passing through a paper discharge path 143.

The paper discharge portion 15 is formed by providing a recess in the top portion of the apparatus main body 11, and a paper discharge tray 151 for receiving a discharged recording sheet P is formed at the bottom portion of the concave portion in the recess.

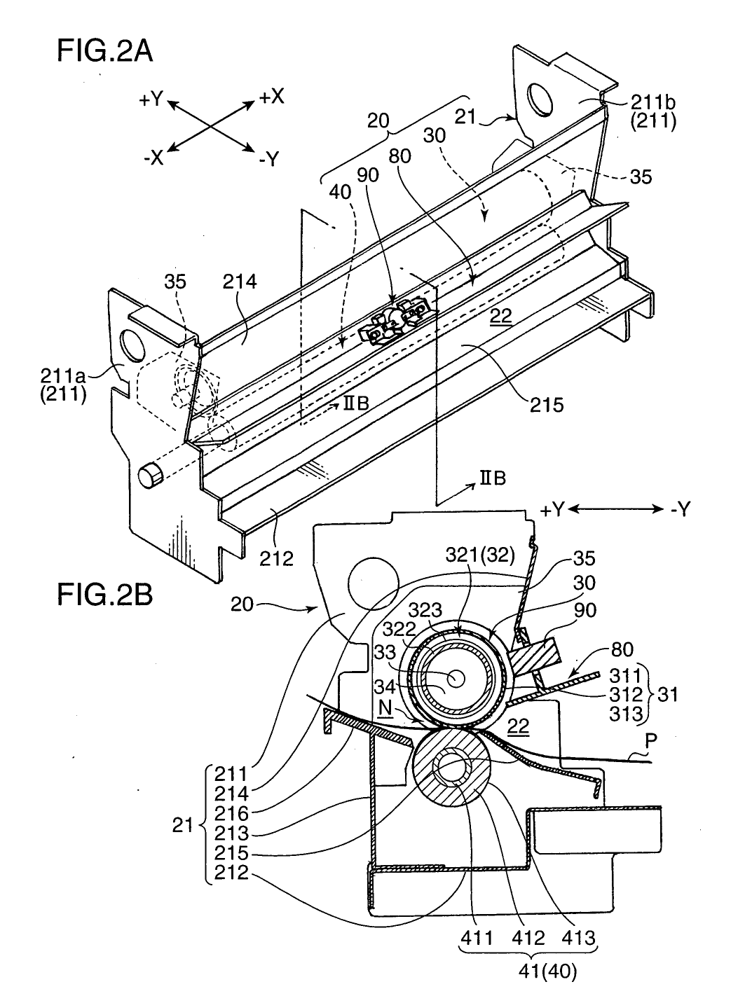

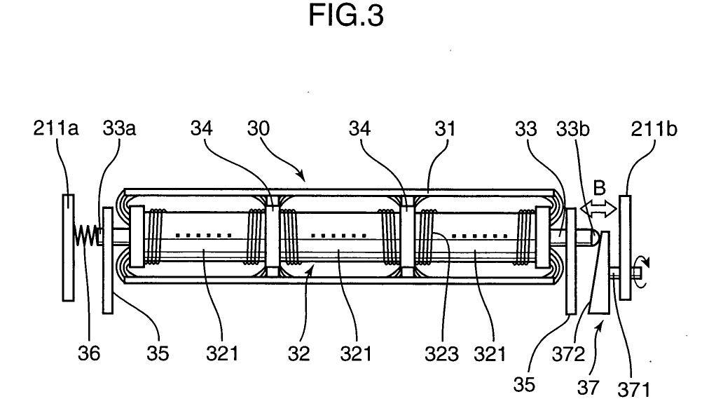

The configuration of the fixing device 20 of the first embodiment of the invention will now be described. FIG. 2A and FIG. 2B are views showing the configuration of the fixing device 20. FIG. 2A is a schematic perspective view and FIG. 2B is a cross section taken on line IIB-IIB of FIG. 2A. FIG. 3 is a sectional explanatory view showing a major configuration of a reciprocal driving mechanism in the fixing device 20. Referring to FIG. 2A and the following drawings, the X-X direction is defined as the right-left direction, and the Y-Y direction is defined as the front-back direction. In particular, the −X direction is defined as the left, the +X direction as the right, the −Y direction as the front, and the +Y direction as the rear.

As is shown in FIG. 2A, the fixing device 20 is formed by installing the heat roller 30 and the pressure roller 40 disposed oppositely at the top and the bottom inside a housing 21 exhibiting an irregular shape that is long in the right-left direction, bridging a supporting member 80 that is long in the right-left direction across the housing 21 in the center portion in the top-bottom direction at the front position, and attaching a thermistor 90 that detects the temperature of peripheral surface of the heat roller 30 to the supporting member 80 at the center position in the right-left direction.

The housing 21 includes a crosswise pair of side plates 211 of an irregular shape (a side plate 211a on the left and a side plate 211b on the right), a bottom plate 212 bridging between the pair of side plates 211 at the lower positions and exhibiting a step-like shape when viewed from a side surface, a rear plate 213 provided to stand on the bottom plate 212 from the rear end position and covering the rear lower half of the housing 21, a front plate 214 bridging between the pair of side plates 211 at the upper half on the front edge, a front guide plate 215 bridging between the pair of side plates 211 at the lower half on the front edge at a position above the bottom plate 212 and guiding a recording sheet P to the nip portion N, and a rear guide plate 216 fixed to the top edge portion of the rear plate 213 at the rear position of the pair of side plates 211 and guiding the recording sheet P from the nip portion N to the outside.

The supporting member 80 is disposed oppositely to the peripheral surface of the heat roller 30, and bridges between the pair of side plates 211 to close a large space defined in the housing 21 between the front plate 214 and the front guide plate 215. The thermistor 90 is a ceramic semiconductor chiefly made of metal oxides and sintered at a high temperature. It has a negative temperature coefficient by which the resistance value drops with a rise in temperature, and serves as a temperature sensor to detect the temperature of the peripheral surface of the heat roller 30.

A high-frequency current supplied to a coil 32 described below is adjusted in an unillustrated control portion according to a signal relating to the temperature of the peripheral surface of the heat roller 30 detected by the thermistor 90, so that the temperature of the peripheral surface of the heat roller 30 is controlled to stay at a specific temperature. The thermistor 90 is held by the supporting member 80 almost at the center position in the right-left direction while the temperature detecting surface opposes the peripheral surface of the heat roller 30.

The front guide plate 215 is formed to overhang forward with the tip end pointing downward while the rear edge portion faces the nip portion N. Meanwhile, the supporting member 80 is set to an installation posture so as to tilt forward with the tip end pointing upward while the rear edge portion faces the peripheral surface of the heat roller 30. An introduction opening 22 through which a recording sheet P is introduced to the nip portion N is defined by a space between the front guide plate 215 and the supporting member 80. A recording sheet P sent from the image forming portion 13 is sent toward the nip portion N as it is guided by the front guide plate 215 and the supporting member 80 that open wide at the front in the introduction opening 22.

The heat roller 30 is formed of a roller main body 31 (heated body) composed of a circular cylindrical body (metal substrate layer 311) made of a metal material (magnetic material), such as iron and nickel, and the coil 32 that is long in the right-left direction 31 (a direction perpendicular to the sheet surface of FIG. 2B) and provided concentrically inside the heat roller body 31. The roller main body 31 is bridged between the pair of side plates 211 while being rotatable about the position at which an axis center body 33 is disposed, which is deemed as the rotational center axis, and is rotationally driven by unillustrated driving motor and speed reducing mechanism. It should be noted that the roller main body 31 is set stationary in the direction in which the axis center body 33 extends (axial direction).

The roller main body 31 is formed of the metal substrate layer 311 composed of a circular cylindrical body made of a metal material (magnetic material), and a mold releasing layer 313 layered on the substrate main surface. An elastic layer 312 may be interposed between the metal substrate layer 311 and the mold releasing layer 313 when the need arises. The roller main body 31 generates heat through induction heating when a high-frequency current is supplied to the coil 32 from an unillustrated high-frequency power supply. The structure of the heat roller 30 will be described in detail below.

A roller main body 41 of the pressure roller 40 is formed of a circular cylindrical body (metal substrate layer 411) made of aluminum alloy, an elastic layer 412 that is provided integrally and concentrically with the metal substrate layer 411 by external fitting, and a mold releasing layer 413 that covers the peripheral surface of the elastic layer 412. The heat roller main body 41 is pressed against the heat roller 30.

The elastic layers 312 and 412, respectively, on the heat roller 30 and the pressure roller 40 are made of an elastic material, such as silicon rubber and silicon foamed rubber, and they become concave as the heat roller 30 and the pressure roller 40 abut on each other. Such elastic deformation defines the nip portion N having appropriate shape (nip width or the like) and elasticity between the heat roller 30 and the pressure roller 40, which makes it possible to achieve a uniform fixing property for a toner image. When silicon rubber is used as the elastic material, the elastic layers 312 and 412 exhibit excellent workability during the fabrication, and when the silicon foamed rubber is used, they exhibit excellent heat insulating property and repulsive elasticity.

The mold releasing layers 313 and 413, respectively, on the surfaces of the heat roller 30 and the pressure roller 40 are obtained by coating the surfaces with a fluorocarbon resin coating material (coating agent), such as poly(tetrafluoroethylene) (PTFE) resin, poly(tetrafluoroethylene-co-hexafluoropropylene) resin (FEP), and poly(tetrafluoroethylene-co-perfluoro-alkylvinyl ether) (PFA) resin. Alternatively, a resin coating agent denatured by adding organic binder resin to the fluorocarbon resin specified above may be used.

By providing the mold releasing layers 313 and 413 on the surfaces of the heat roller 30 and the pressure roller 40, respectively, it is possible to enhance the mold releasing property when a pre-fixed toner image is fused by nipping and carrying a recording medium in the nip portion N between the heat roller 30 and the pressure roller 40. In addition, by using the fluorocarbon resin as specified above, it is possible to enhance the heat resistance and the durability of the heat roller 30 and the pressure roller 40.

In the fixing device 20 configured as above, the heat roller 30 is driven to rotate about the axis center as a driving force of the unillustrated driving motor provided at an appropriate position of the housing 21 is transmitted to the heat roller 30 via the unillustrated speed reducing mechanism. The rotational driving of the heat roller 30 is transmitted to the pressure roller 40 via the nip portion N. The fixing processing is applied to a recording sheet P that has reached the nip portion N as it passes by the nip portion N by driven rotations of the pressure roller 40 in the opposite direction while being heated by the heat roller 30.

Hereinafter, the structure of the heat roller 30 in the fixing device 20 of the first embodiment will be described in detail. As is shown in FIG. 3, the heat roller 30 is formed by disposing the coil 32 divided into plural coil elements 321 in the axial direction parallel to the rotational axis direction of the heat roller main body 31 of a circular cylindrical shape inside the heat roller main body 31.

A copper wire 323 is helically wound around each coil element 321 with turns proceeding in the axial direction of a core material (ferrite) 322. The respective coil elements 321 are aligned concentrically with the heat roller main body 31 in such a manner that the directions of the magnetic fields of the adjacent coil elements 321 are opposite to each other, and each is fixedly supported on an axis center body 33 that penetrates through the heat roller main body 31 in the rotational axis direction. A high-frequency current is supplied to these coil elements 321 from the unillustrated high-frequency power supply.

Upon a supply of the high-frequency current, the coil elements 321 develop high-frequency magnetic fields and an induction eddy current occurs in the heat roller main body 31, which gives rise to Joule heating in the heat roller main body 31 owing to the surface resistance. Because the polarities repel each other in the opposing portions (joint portions) of the adjacent coil elements 321, it is possible to make magnetic fluxes going into the heat roller main body 31 uniform, which can in turn lessen a temperature irregularity of the heat roller main body 31 in the rotational axis direction.

In the first embodiment, coupling members 34 are provided to the opposing portions of the adjacent coil elements 321, and the plural coil elements 321 are coupled to one another with the coupling members 34. On the basis of this configuration, the axis center body 33 is held by a pair of coil supporting plates 35 from the both sides in the axial direction, and the coil 32 is brought into a state where reciprocal driving in the axial driving is enabled. The pair of coil supporting plates 35 is bridged between the front plate 214 and the rear guide plate 216 on the inner side of the pair of side plates 211 of the housing 21.

By allowing one end portion 33a of the axis center body 33 to abut on an elastic pressing member 36 provided to the side plate 211a of the housing 21 on the left, a biasing force is conferred to the coil 32 in a direction to move apart from the side plate 211a. In addition, the other end portion 33b of the axis center body 33 is allowed to abut on an abutting surface 372 of a cam member 37. The cam member 37 is provided to the side plate 211b of the housing 21 on the right (at a position slightly deviated from an extension line of the axis center body 33), and it is driven to rotate about an axis center 371 by unillustrated driving motor and speed reducing mechanism. Herein, a compression spring is used as the elastic pressing member 36. For the driving motor and the speed reducing mechanism for rotationally driving the cam member 37, the driving motor used for rotationally driving the heat roller 30 is used commonly, and the speed reducing mechanism for the heat roller 30 is utilized in part.

When configured in this manner, by rotationally driving the cam member 37 about the axis center 371, the abutting surface 372 of the cam member 37 undergoes displacement in the rotational axis direction of the heat roller main body 31 (see an arrow B in FIG. 3), and the coil 32 (axis center body 33) is pressed by the abutting surface 372 so as to be driven reciprocally in the same axial direction. In other words, the reciprocal driving mechanism is to cause the axis center body 33 to undergo displacement in the axial direction relatively with respect to the roller main body 31 by the displacement of the abutting surface 372 caused when the cam member 37 is rotationally driven. The shape of the abutting surface 372 is set for the displacement to draw gentle curve-like loci.

In the first embodiment, a quantity of displacement of the reciprocal driving (a quantity of displacement of the abutting surface 372 of the cam member 37) can be changed by replacing the cam member 37 to another one, and the quantity can be changed within a range of 5 to 20 mm. The frequency of the reciprocal driving (the number of rotations of the cam member 37) can be set within a range of 30-120 cycles/min. It is preferable to coat a fluorocarbon resin coating material (coating agent) on the axis center body 33 of the coil 32 and the abutting surface 372 of the cam member 37 in portions where they come into sliding contact with each other to keep the surfaces in a state where the frictional coefficient is small. This suppresses wearing of the both members 34 and 372, which can in turn enhance the reliability of the actions described above.

As has been described, in the first embodiment, the reciprocal driving mechanism can be achieved by the configuration as simple as by combining the axis center body 33 of the coil 32 and the cam member 37 on the housing 21 side that abuts on the axis center body 33.

The coupling member 34 is formed as a ring-shaped magnetic body whose outer peripheral surface is close to the inner peripheral surface of the heat roller main body 31. By interposing the coupling member 34 configured in this manner, magnetic fluxes generated from the respective coil elements 321 are allowed to go into the heat roller main body 31 as they are guided by the coupling members 34. It is thus possible to lessen temperature drops in the opposing portions of the adjacent coil elements 321. It should be noted that the plural coil elements 321 are not necessarily coupled to one another with the coupling members 34, and they may be coupled to one another with a certain space in between.

The number of the divided coil elements 321 shown in the drawing is three in the first embodiment. However, the number of divided parts is not limited to three, and it may be two or four or more.

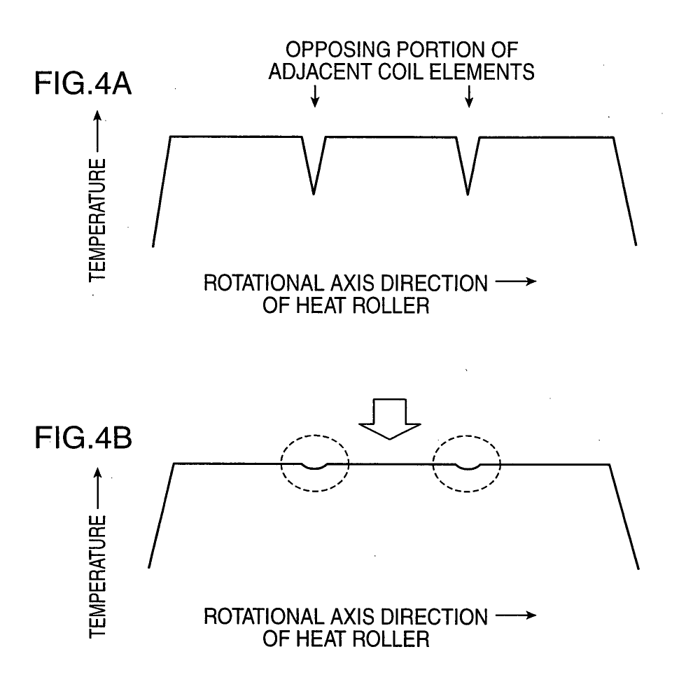

For the temperature distribution on the surface of the heat roller main body 31 in the fixing device 20 having the reciprocal driving mechanism configured as above, one example of the measurement result will be shown. FIGS. 4A and 4B are explanatory views showing the temperature distribution of the heated body in the fixing device. FIG. 4A shows the temperature distribution in a fixing device in the related art and FIG. 4B shows the temperature distribution in the fixing device 20 of the first embodiment.

With the temperature distribution of the heat roller 30 in the rotational axis direction in a state where the reciprocating driving mechanism is not operating (or in a state where the reciprocal driving mechanism is not provided), as is shown in FIG. 4A, a noticeable temperature drop is acknowledged in the opposing portions of the adjacent coil elements 321. However, in a state where the reciprocal driving mechanism is operated, as is shown in FIG. 4B, it is understood that drops of the magnetic fields in the opposing portions of the adjacent coil elements 321 are leveled, which in turn suppresses local temperature drops.

By reciprocally driving the coil 32 in this manner, local temperature drops can be suppressed by leveling drops of the magnetic fields in the opposing portions of the adjacent coil elements 321. It is thus possible to prevent the occurrence of a temperature irregularity of the heat roller 30 in the rotational axis direction. Because the resulting homogenous heat is transmitted to a recording sheet P sent to the nip portion N, the pre-fixed toner image on the recording sheet P is fused uniformly in the rotational axis direction of the nip portion N (heat roller 30). It is thus possible to prevent the occurrence of irregularities in an image.

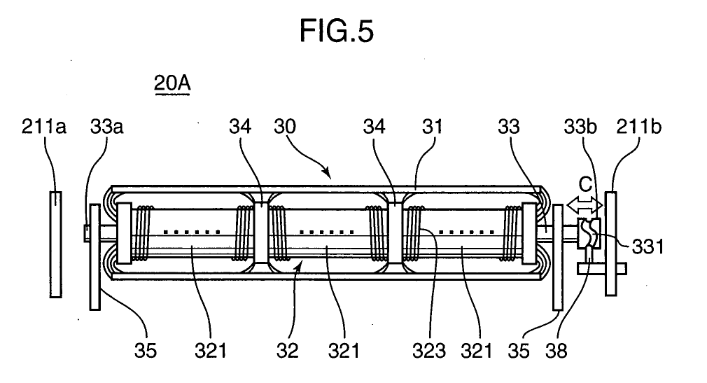

The configuration of a fixing device 20A according to a second embodiment of the invention will now be described. FIG. 5 is a sectional explanatory view showing a major configuration of the reciprocal driving mechanism in the fixing device according to the second embodiment of the invention. Because the fixing device 20A is the same as the counterpart in the first embodiment except for the reciprocal driving mechanism, like components are labeled with like reference numerals and descriptions of such components are omitted herein.

In the second embodiment, the axis center body 33 of the coil 32 coupled by the coupling members 34 is held by the pair of coil supporting plates 35 from the both sides in a state where rotational driving and reciprocal driving are enabled. An engagement groove 331 is provided to the other end potion 33b of the axis center body 33 by concavely carving in the axis side surface, and an engaging member 38 is engaged in this engagement groove 331 from the side. The engaging member 38 is provided to the side plate 211b (at a position slightly deviated from an extension line of the axis center body 33) of the housing 21 on the right side to protrude toward the axis center body 33.

In the first embodiment above, the axis center body 33 is fixed while the cam member 37 is rotationally driven. On the contrary, in the second embodiment, the engaging member 38 is fixed and the axis center body 33 is rotationally driven. The axis center body 33 is rotationally driven by unillustrated driving motor and speed reducing mechanism provided at the end of the other end portion 33b of the axis center body 33. For the driving motor and the speed reducing mechanism used for this rotational driving, the driving motor used for rotationally driving the heat roller 30 is used commonly and the speed reducing mechanism for the heat roller 30 is utilized in part. It may be possible to provide the driving motor and the speed reducing mechanism for rotationally driving the axis center body 33 at the end of the one end portion 33a. However, by taking into account that the driving motor and the speed reducing mechanism for rotationally driving the heat roller 30 are used commonly as a general rule, it is preferable to provide those for the axis center body 33 on the same side.

When configured in this manner, by rotationally driving the axis center body 33 of the coil 32, the coil 32 (axis center body 33) is reciprocally driven in the rotational axis direction of the heat roller main body 31 (see an arrow C in FIG. 5) in response to a quantity of displacement of the engagement groove 331 in the axial direction in which the engaging member 38 is engaged. In other words, the engagement groove 331 is placed under the constraint of the engaging member 38 that is engaged therein as the axis center body 33 is rotationally driven, and causes the axis center body 33 to undergo displacement in the axial direction. The shape thereof is set for the displacement to draw gentle curve-like loci.

Herein, a quantity of displacement of the reciprocal driving (a quantity of displacement of the engagement groove 331) is set within a range of 5 to 20 mm. The frequency of the reciprocal driving (set by the number of rotations of the axis center body 33) can be set within a range of 30 to 120 cycles/min. It is preferable to coat a fluorocarbon resin coating material on the engagement groove 331 in the axis center body 33 and the engaging member 38 on the housing body 21 side in portions where they come into sliding contact with each other to keep the surfaces in a state where the frictional coefficient is small. This suppresses wearing of the both members 331 and 38, which can in turn enhance the reliability of the actions.

As has been described, in the second embodiment, the reciprocal driving mechanism can be achieved by the configuration as simple as by combining the engagement groove 331 in the axis center body 33 of the coil 32 and the engaging member 38 on the housing 21 side that is engaged therein.

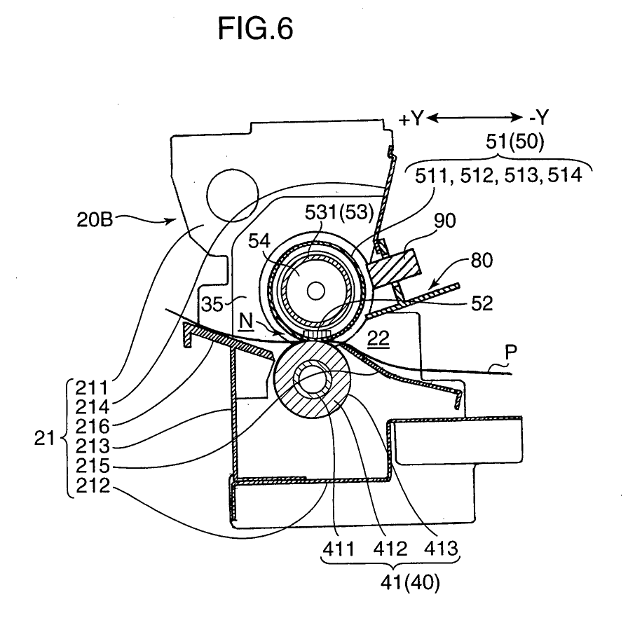

The configuration of a fixing device 20B according to a third embodiment of the invention will now be described. FIG. 6 is a cross section same as FIG. 2B showing the configuration of the fixing device according to the third embodiment of the invention. Because the fixing device 20B is the same as the counterpart in the first embodiment except that a thin heating belt 50 is used instead of the heat roller 30, like components are labeled with like reference numerals and descriptions of these components are omitted herein.

The fixing device 20B includes an endless heating belt 50 (heated body) that is heated by means of induction heating, a pad member 52 made of a non-magnetic material and configured to abut on the heating belt 50 from the inside, and a pressure roller 40 that presses the pad member 52 via the heating belt 50. A pre-fixed toner image is fused as heat is conferred to a recording sheet P bearing the pre-fixed toner image while it is nipped in a nip portion N between the heating belt 50 and the pressure roller 40.

A belt main body 51 of the heating belt 50 is an endless belt formed of at least a metal substrate layer 512 made of magnetic metal. Herein, the belt main body 51 is formed by layering the metal substrate layer 512 using a thin plate of magnetic metal, a resin substrate layer 511 made of heat resistant resin and formed on the inner side of the metal substrate layer 512, and a mold releasing layer 514 made of the same material as that of the mold releasing layer 413 and formed on the outer side of the metal substrate layer 512.

An elastic layer 513 made of the same material as that of the elastic layer 412 may be interposed between the metal substrate layer 512 and the mold releasing layer 514 when the need arises. Polyimide (PI), polyamideimide (PAI), polyether ketone (PEEK), and so forth can be used as the heat resistant resin. The metal substrate layer 512 may be molded from resin same as the heat resistant resin specified above with powder of magnetic metal being dispersed therein. Alternatively, it may be configured in such a manner that plural resin layers and metal substrate layers 512 both made of heat resistant resin are formed alternately in plural layers and the mold releasing layer 514 is layered on top of these layers. When configured in this manner, not only the strength and the heat resistance, but also the flexibility of the heating belt 50 can be enhanced.

The pad member 52 is made of a non-magnetic material (for example, resin, silicon rubber, or the like), and it is held by coupling members 54 described below while a fluorocarbon resin coating material is coated thereon in a portion that abuts on the inner surface of the heating belt 50 (rein substrate layer 511) to keep the surface in a state where the frictional coefficient is small. Hence, even when a high-frequency current flows into the coil 53, the pad member 52 will not generate heat, and even when reciprocally driven together with the coil 53 in the axial direction thereof, it will not wear out from the abutting on the heating belt 50.

The coil 53 is disposed inside the heating belt 50, and heats the heating belt 50 (metal substrate layer 512) by means of induction heating. The coil 53 is formed of plural coil elements 531 divided in the axial direction thereof, and the coil elements 531 are aligned in such a manner that the directions of the magnetic fields of the adjacent coil elements 531 are opposite to each other. The coil elements 531 are linked to one another with the linking members 54, and the linked coil 53 is reciprocally driven in the axial direction by the reciprocal driving mechanism provided in the same manner as the first or second embodiment.

In the fixing device 20B configured in this manner, temperature drops are suppressed by leveling drops of the magnetic fields in the opposing portions of the adjacent coil elements 531 as the coil 53 is reciprocally driven in the axial direction. It is thus possible to prevent the occurrence of a temperature irregularity of the heating belt 50 in the rotational axis direction.

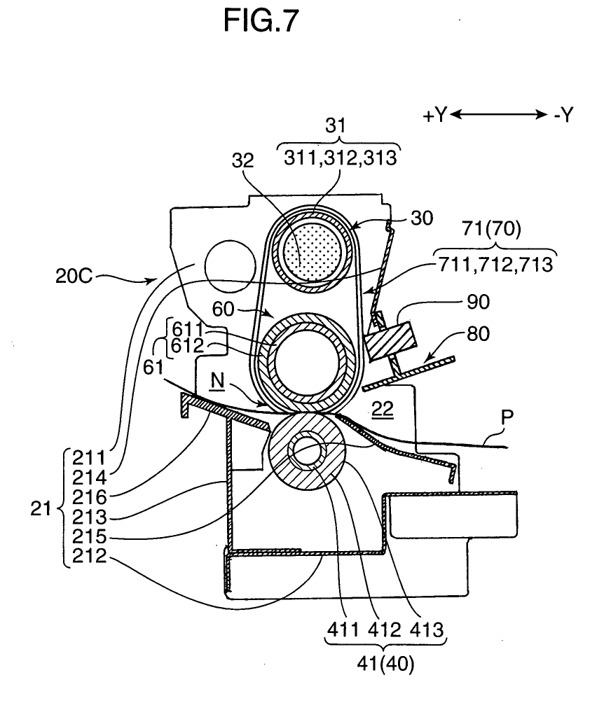

The configuration of a fixing device 20C according to a fourth embodiment of the invention will now be described. FIG. 7 is a cross section same as FIG. 2B showing the configuration of the fixing device according to the fourth embodiment of the invention. As with the heat roller 30 in the first embodiment, the fixing device 20C is formed of a heat roller 30 (heated body) provided with a coil 32 (plural coil elements 321) inside thereof, a fixing roller 60 disposed oppositely below the heat roller 30, a heat transfer belt 70 stretched over the fixing roller 60 and the heat roller 30, and a pressure roller 40 disposed oppositely to the fixing roller 60 via the heat transfer belt 70. A pre-fixed toner image on a recording sheet P sent through an introduction opening 22 is fused in a nip portion N defined at the position at which the fixing roller 60 and the pressure roller 40 abut on each other via the heat transfer belt 70. The configurations and components same as those of the fixing device 20 in the first embodiment are labeled with the same reference numerals and descriptions thereof are omitted herein.

The heat roller 30 has the same configuration as that of the heat roller used in the first embodiment, and it is formed by disposing the coil 32 divided into plural coil elements 321 in the axial direction parallel to the rotational axis direction of the heat roller main body 31 of a circular cylindrical shape inside the heat roller main body 31. It is configured in such a manner that the heat roller 30 is heated by means of induction heating using the coil 32 (coil elements 321), and heat is transmitted to the heat transfer belt 70 via the heat roller 30 over which it is stretched.

As the mechanism to reciprocally drive the coil 32 in the axial direction, a cam member 37 same as the one in the first embodiment, or a combination of an engagement groove 331 and an engaging member 38 same as those in the second embodiment may be used.

A roller main body 61 of the fixing roller 60 is formed of a metal substrate layer 611 composed of a circular cylindrical body made of aluminum alloy, and an elastic layer 612 of a circular cylindrical shape that is made of silicon rubber or silicon foamed rubber and provided integrally and concentrically with the metal substrate layer 611 by external fitting. The roller main body 61 is pressed by the pressure roller 40 via the heat transfer belt 70.

The heat transfer belt 70 is-to fuse a pre-fixed toner image on a recording sheet P by transferring heat from the heat roller 30 that is heated by the coil 32 by means of induction heating at a nip portion N defined between the heat transfer belt 70 and the pressure roller 40. A heat transfer belt main body 71 is formed to have at least a metal substrate layer 711 on the innermost peripheral side. It may be configured in such a manner that an elastic layer 712 and a mold releasing layer 713 made of the same materials as those of the elastic layer 412 and the mold releasing layer 413 described above are layered on the outer side of the belt main body 71. Metal used for the metal substrate layer 711 is not particularly limited, and arbitrary metal can be used.

In the fixing device 20C configured in this manner, local temperature drops are suppressed by leveling drops of the magnetic fields in the opposing portions of the adjacent coil elements 321 as the coil 32 is reciprocally driven by the driving of the cam member 37 or the like. It is thus possible to prevent the occurrence of a temperature irregularity of the heat roller 30 in the rotational axis direction. By transferring the resulting homogeneous heat to the nip portion N between the heat transfer belt 70 and the pressure roller 40 via the heat transfer belt 70, the occurrence of a temperature irregularity in the nip portion N can be prevented, which in turn makes it possible to prevent the occurrence of irregularities in an image.

While the fixing devices 20, 20A, 20B, and 20C of the invention have been described, it should be appreciated that by forming an image forming apparatus equipped with any of the fixing devices 20 through 20C in the first through fourth embodiments, it is possible to obtain an image forming apparatus capable achieving the same advantages as those described in the respective embodiments above.

It should be appreciated that the embodiments disclosed above are illustrative and not restrictive. The technical scope of the invention is not limited by the descriptions of the embodiments above, but limited solely by the scope of the appended claims, and further, it is understood that any meaning equivalent to the scope of the appended claims and all modifications within the scope are included in the invention.

### Modifications of the Embodiments

Hereinafter, modifications will be described, in which the functions are modified or added in part instead of or in addition to those in the embodiments above.

1) In the first through third embodiments, the coil 32 or 52 that heats the heated body (heat roller 30 or heating belt 50) by means of induction heating is disposed and accommodated in the heated body 30 and 50. However, the fixing device 20 of the invention is not limited to this configuration.

For example, a coil made into a single piece by linking plural coil elements divided in the axial direction may be disposed on the outside of the heat roller 30 or the heating belt 50 in such a manner that the coil is reciprocally driven in the axial direction thereof. In this case, too, the magnetic fields become weaker in the opposing portions of the adjacent coil elements and local temperature drops readily occur by merely disposing the coil on the outside of the heated body 30 or 50. However, by reciprocally driving the coil in the axial direction, it is possible to confer desired distribution and orientation of temperature by suppressing such local temperature drops.

2) In the first through third embodiments, it is configured in such a manner that the divided coil elements 321 or 521 are linked to one another with the linking members 34 or 53 formed of a ring-shaped magnetic body whose outer peripheral surface is disposed in close proximity to the inner peripheral surface of the roller main body. However, the linking members 34 or 53 configured as above are not necessarily used, and the coil elements 321 or 521 may be linked to one another with a specific space in between. It should be noted, however, that when the linking members 34 or 53 described above are used, because the outer peripheral surfaces thereof are in close proximity to the inner peripheral surface of the heated body (heat roller main body 31 or the heating belt 50), magnetic fluxes generated in the respective coil elements 321 or 521 are allowed to go into the heated body 31 or 50 as they are guided by the linking members 34 or 53. It is therefore possible to effectively lessen temperature drops in the opposing portions of the adjacent coil elements 321 or 521.

3) In the first and second embodiments above, two examples have been described as the mechanism that reciprocally drives the coil 32 or 52 in the axial direction. However, the invention is not limited to these examples, and the number of rotations (frequency) and a quantity of driving during the reciprocal driving are not limited to those specified as above, either. In short, any mechanism is available as long as it is mechanically simple and is able to perform reciprocal driving in a reliable manner, and the driving conditions can be set so as to suit the method used.

The concrete embodiments described above chiefly contain inventions having the configurations as follows.

A fixing device according to one aspect of the invention includes a heated body of a hollow cylindrical shape that is made of a conductive material and driven to rotate about an axis center, and a coil that heats the heated body by means of induction heating, wherein the coil is formed of plural coil elements divided in an axial direction of the coil parallel to a rotational axis direction of the heated body and the coil elements are aligned in such a manner that directions of magnetic fields of adjacent coil elements are opposite to each other, and the heated body is set stationary in the rotational axis direction and the coil is reciprocally driven in the axial direction.

According to this configuration, the coil is divided into plural coil elements in the axial direction of the coil parallel to the rotational axis direction of the heated body, and the coil elements are aligned in such a manner that the directions of the magnetic fields of adjacent coil elements are opposite to each other. When magnetic fluxes are generated from the respective coil elements by flowing a high-frequency current to these coil elements, the polarities repel each other in the opposing portions of the adjacent coil elements, which can make the magnetic fluxes going into the heated body uniform. Further, because local drops of the magnetic fields in the opposing portions of the coil elements are leveled by reciprocally driving the coil in the axial direction, it is possible to suppress local temperature drops resulting from such drops. Temperature drops of the heated body in the rotational axis direction are thus lessened, and it is therefore possible to achieve a fixing device that has desired distribution and orientation of temperature and is consequently capable of preventing the occurrence of irregularities in an image.

In the configuration described above, it is preferable that the coil is provided concentrically with the heated body inside the heated body.

According to this configuration, the coil is disposed concentrically with the heated body by utilizing a space inside the heated body. This allows homogeneous magnetic fluxes to go into the heated body, which is being rotationally driven, along the circumferential direction. Hence, because generated heat is dispersed uniformly, it is possible to suppress the occurrence of a temperature irregularity in the rotational axis direction. In addition, because fewer components are disposed on the outside of the heated body, a compact fixing device can be achieved.

In the configuration described above, it is preferable that the coil elements are linked to one another with linking members formed of a ring-shaped magnetic body whose outer peripheral surface is close to an inner peripheral surface of the heated body.

The plural coil elements may be linked to one another with a certain space in between. However, by interposing the linking members, magnetic fluxes generated in the respective coil elements are allowed to go into the heated body as they are guided by the linking members. This makes it possible to lessen temperature drops in the opposing portions of the adjacent coil elements.

In the configuration described above, it is preferable that the heated body is a heat roller of a cylindrical shape.

According to this configuration, because the heated body is a heat roller of a cylindrical shape that is used typically, by applying the coil and the reciprocal driving mechanism thereof as described above to the fixing device of the typical configuration in the related art, it is possible to confer uniform and desired distribution and orientation of temperature.

In the configuration described above, it is preferable that the heated body is an endless heating belt.

According to this configuration, the heated body is an endless heating belt, and by applying the coil and the reciprocal driving mechanism as described above to the fixing device configured as above, it is possible to confer uniform and desired distribution and orientation of temperature. Moreover, because the heating belt is thinner than a typical heat roller and has flexibility, it can be readily formed as a component having a small heat capacity. Hence, by using the heating belt as above, it is possible to further shorten a warm-up time and save energy.

An image forming apparatus according to another aspect of the invention includes: an image forming portion configured to apply transfer processing of a toner image to a recording sheet; a fixing portion configured to apply fixing processing to the recording sheet onto which the toner image has been transferred; and an apparatus main body that accommodates the image forming portion and the fixing portion, wherein the fixing portion includes a heated body of a hollow cylindrical shape that is made of a conductive material and driven to rotate about an axis center, and a coil that heats the heated body by means of induction heating, and wherein the coil is formed of plural coil elements divided in an axial direction of the coil parallel to a rotational axis direction of the heated body and the coil elements are aligned in such a manner that directions of magnetic fields of adjacent coil elements are opposite to each other, and the heated body is set stationary in the rotational axis direction and the coil is reciprocally driven in the axial direction.

According to this configuration, it is possible to provide an image forming apparatus equipped with a fixing device of an induction heating method using the coil divided into plural coil elements and capable of achieving desired distribution and orientation of temperature by suppressing local temperature drops in the opposing portions of the adjacent coil elements.

In the configuration described above, it is preferable that: the coil is provided concentrically with the heated body inside the heated body; the coil elements are linked to one another with linking members formed of a ring-shaped magnetic body whose outer peripheral surface is close to an inner peripheral surface of the heated body; and the heated body is a heat roller of a cylindrical shape or the heated body is an endless heating belt.

In the configuration described above, it is preferable to further include: an axis center body that penetrates through a hollow portion of the coil to fixedly support the coil; two coil supporting plates that hold the axis center body on both sides in such a manner that the axis center body is allowed to move in an axial direction thereof; a biasing member that is provided in a space between one wall surface of the apparatus main body and one end portion of the axis center body and confers a biasing force to the one end portion in a direction to cause the coil to move apart from the one wall surface; and a cam member that is provided to the other side wall of the apparatus main body and has an abutting surface on which the other end portion of the axis center body abuts, wherein the abutting surface undergoes displacement in the axial direction as the cam member is rotationally driven, so that the coil is biased by the abutting surface and reciprocally driven in the axial direction.

Alternatively, it is preferable to further include: an axis center body that penetrates through a hollow portion of the coil to fixedly support the coil; two coil supporting plates that hold the axis center body on both sides in such a manner that the axis center body is allowed to move in an axial direction thereof; an engagement groove that is carved in a side surface of one end portion of the axis center body; and an engaging member that is provided to one side wall of the apparatus main body and engaged in the engagement groove, wherein the coil is reciprocally driven in the axial direction in response to a quantity of displacement in the axial direction of the engagement groove in which the engaging member is engaged as the axis center body is rotationally driven.

According to any of the foregoing configurations, it is possible to achieve a reciprocal driving mechanism of the coil with a simple configuration.

This application is based on patent application No. 2006-050181 filed in Japan, the contents of which are hereby incorporated by references.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. A fixing device, comprising:
a heated body of a hollow cylindrical shape that is made of a conductive material and driven to rotate about an axis center; and
a coil that heats the heated body by means of induction heating,
wherein:
the coil is formed of plural coil elements divided in an axial direction of the coil parallel to a rotational axis direction of the heated body, and the coil elements are aligned in such a manner that directions of magnetic fields of adjacent coil elements are opposite to each other; and
the heated body is set stationary in the rotational axis direction and the coil is reciprocally driven in the axial direction.

2. The fixing device according to claim 1, wherein:
the coil is provided concentrically with the heated body inside the heated body.

3. The fixing device according to claim 1, wherein:
the coil elements are linked to one another with linking members formed of a ring-shaped magnetic body whose outer peripheral surface is close to an inner peripheral surface of the heated body.

4. The fixing device according to claim 1, wherein:
the heated body is a heat roller of a cylindrical shape.

5. The fixing device according to claim 1, wherein:
the heated body is an endless heating belt.

6. An image forming apparatus, comprising:
an image forming portion configured to apply transfer processing of a toner image to a recording sheet;
a fixing portion configured to apply fixing processing to the recording sheet onto which the toner image has been transferred; and
an apparatus main body that accommodates the image forming portion and the fixing portion,
wherein the fixing portion includes:
a heated body of a hollow cylindrical shape that is made of a conductive material and driven to rotate about an axis center; and
a coil that heats the heated body by means of induction heating, and
wherein:
the coil is formed of plural coil elements divided in an axial direction of the coil parallel to a rotational axis direction of the heated body, and the coil elements are aligned in such a manner that directions of magnetic fields of adjacent coil elements are opposite to each other; and
the heated body is set stationary in the rotational axis direction and the coil is reciprocally driven in the axial direction.

7. The image forming apparatus according to claim 6, wherein:
the coil is provided concentrically with the heated body inside the heated body.

8. The image forming apparatus according to claim 6, wherein:
the coil elements are linked to one another with linking members formed of a ring-shaped magnetic body whose outer peripheral surface is close to an inner peripheral surface of the heated body.

9. The image forming apparatus according to claim 6, wherein:
the heated body is a heat roller of a cylindrical shape.

10. The image forming apparatus according to claim 6, wherein:
the heated body is an endless heating belt.

11. The image forming apparatus according to claim 6, further comprising:
an axis center body that penetrates through a hollow portion of the coil to fixedly support the coil;
two coil supporting plates that hold the axis center body on both sides in such a manner that the axis center body is allowed to move in an axial direction thereof;
a biasing member that is provided in a space between one wall surface of the apparatus main body and one end portion of the axis center body and confers a biasing force to the one end portion in a direction to cause the coil to move apart from the one wall surface; and
a cam member that is provided to the other side wall of the apparatus main body and has an abutting surface on which the other end portion of the axis center body abuts,
wherein:
the abutting surface undergoes displacement in the axial direction as the cam member is rotationally driven, so that the coil is biased by the abutting surface and reciprocally driven in the axial direction.

12. The image forming apparatus according to claim 6, further comprising:
an axis center body that penetrates through a hollow portion of the coil to fixedly support the coil;
two coil supporting plates that hold the axis center body on both sides in such a manner that the axis center body is allowed to move in an axial direction thereof;
an engagement groove that is carved in a side surface of one end portion of the axis center body; and
an engaging member that is provided to one side wall of the apparatus main body and engaged in the engagement groove,
wherein:
the coil is reciprocally driven in the axial direction in response to a quantity of displacement in the axial direction of the engagement groove in which the engaging member is engaged as the axis center body is rotationally driven.
